(19) United States
(12) Patent Application Publication
(10) Pub. No.: US 2026/0197037 A1
(43) Pub. Date: Jul. 9, 2026

(54) CONTROL ENTITY FOR A WIRELESS COMMUNICATION SYSTEM AND METHOD

(71) Applicant: HUAWEI TECHNOLOGIES CO., LTD., Shenzhen (CN)

(72) Inventors: Michel Saideh, Boulogne Billancourt (FR); Mohamed KAMOUN, Boulogne Billancourt (FR); Mustapha AMARA, Boulogne Billancourt (FR); Melissa DUARTE GELVEZ, Boulogne Billancourt (FR); Mahdi SHAKIBA HERFEH, Boulogne Billancourt (FR); Chengjun Shao, Hangzhou (CN)

(73) Assignee: HUAWEI TECHNOLOGIES CO., LTD., Shenzhen (CN)

(21) Appl. No.: 19/535,240

(22) Filed: Feb. 10, 2026

Related U.S. Application Data
(63) Continuation of application No. PCT/EP2023/072253, filed on Aug. 10, 2023.

(51) Int. Cl. H04B 7/04; H04L 25/02

(52) U.S. Cl. CPC H04B 7/04013; H04L 25/0228

(57) ABSTRACT

The disclosure provides a control entity for a wireless communication system comprising a receiver node, a transmitter node and a digitally controllable scatterer (DCS), the DCS comprising a plurality of controllable scattering elements. The control entity is configured to receive, from the receiver node, an estimated direct channel between the transmitter node and the receiver node; determine one or more sets of scattering elements, each set comprising one or more of the plurality of scattering elements; and perform, jointly with the receiver node, a recursive process to estimate one or more effective concatenated channels between the transmitter node and the receiver node via respectively the one or more sets of scattering elements, and to determine a phase configuration for the one or more scattering elements of each of the one or more sets based on the estimated effective concatenated channels and based on the estimated direct channel.

### CROSS-REFERENCE TO RELATED APPLICATIONS

This application is a continuation of International Application No. PCT/EP2023/072253, filed on Aug. 10, 2023, the disclosure of which is hereby incorporated by reference in its entirety.

### TECHNICAL FIELD

The disclosure relates to wireless communication systems using a digitally controllable scatterer (DCS). The disclosure provides a control entity for a wireless communication system comprising a receiver node, a transmitter node, and a DCS, the DCS comprising a plurality of controllable scattering elements. The disclosure further provides a corresponding method and a computer program product.

### BACKGROUND

In DCS-aided communications systems, the DCS is placed in a propagation environment with a transmitter and a receiver. The DCS can be implemented as a surface composed of S scattering elements, and each scattering element provides the ability of controlling the phase of its scattered signal. A DCS may be also referred to as a reconfigurable intelligent surface (RIS), an intelligent reflecting surface (IRS), a large intelligent surface (LIS), or a smart repeater.

### SUMMARY

As depicted in FIG. 1, the DCS can be implemented as a single block or as multiple blocks, as plane surfaces or any type of surface, an aggregation of surfaces or a subsurface of one or more DCSs.

FIG. 2 illustrates an example for a conventional DCS-aided communications system, in which two nodes 201, 202 are communicating with the support of the DCS 203, which comprises the S scattering elements 204.

In the exemplary communications system of FIG. 2, the receiver node 202 may comprise a plurality of receiving antennas, and the transmitting node 201 may comprise a plurality of transmitting antennas. A t-th received sample at a receiving antenna of the plurality of the receiving antennas from a transmitter antenna of the plurality of the transmitting antennas can be written as in Equation (1):

$${y}_{t} = ( {v}^{H} {h}_{b} + {h}_{d} ) {x}_{t} + {η}_{t} , \qquad ( 1 )$$

where:
   xₜ∈ [symbol] ^{1×1} is a t-th transmitted sample from the transmitting node 201.
   ηₜ∈ [symbol] ^{1×1} is a t-th additive noise sample.
   h_{d}∈ [symbol] ^{1×1} is a direct channel that represents the electromagnetic environment the transmitting signal goes through to reach the receiver node 202 without being scattered by the DCS 203.
   h_{b}∈ [symbol] ^{S×1} represents a concatenated channel between the transmitting node 201 and the receiver node 202 where h_{b}=diag(h_{rx-dcs})h_{dcs-tx}.
   h_{dcs-tx}∈ [symbol] ^{S×1} is a channel vector that represents the electromagnetic environment the transmitting signal goes through to reach the S DCS scattering elements 204.
   h_{rx-dcs}∈ [symbol] ^{1×S} is a channel vector that represents the electromagnetic environment the scattered signal from the DCS 203 goes through to reach the receiver node 202.
   diag(h_{rx-dcs})∈ [symbol] ^{S×S} is a diagonal matrix including the elements of the vector h_{rx-dcs}.
   v^{H}∈ [symbol] ^{1×S} is a DCS configuration vector of the S DCS scattering elements 204, which is a function of the phases applied to the scattering elements 204.

One of the main challenges of using a DCS is properly configuring it. The DCS configuration consists in configuring the phases of the scattering elements of the DCS. Configuring the DCS allows to adapt (i.e., control or program) the channel conditions and this can be used, for example, for improved communication.

The design of a DCS configuration vector v depends on the channels h_{d}a and h_{b}. However, in this DCS-aided communications system, the DCS concatenated channel, h_{b}, has a large dimension. This is due to the potentially large number of DCS elements, S>>1. Estimating such a high dimension DCS concatenated channel requires a large amount of resources (e.g., a large number of pilot signals that consume a copious amount of time, frequency and/or energy resources).

Current solutions consider sequential and independent DCS designs (or configurations) for the channel estimation and data communication stages. This means that the design or configuration of the DCS during channel estimation and data communication might lead to completely different DCS configuration patterns: A DCS configuration pattern for a channel estimation stage and another pattern for a data communication stage.

An ON/OFF algorithm has been proposed where, during the channel estimation stage and with each received pilot, all the DCS scattering elements are turned off and only one element is turned ON to allow estimating the DCS effective concatenated channel of that ON element. This approach consumes a lot of resources where a single pilot is needed to estimate the channel of each DCS scattering element. Also, needing the ON/OFF capability is a strong constraint, since it may increase complexity and may increase the cost of the DCS embodiment.

In another current solution, the DCS is divided into a fixed number of M disjoint tiles of DCS scattering elements, where a tile is a group or set of the DCS scattering elements. Then, the effective concatenated channel between the transmitting node and the receiving node via each tile is estimated using one pilot. This approach suffers from a lack of flexibility since in some cases it may require a large number M of tiles while in other cases a small number M of tiles may be required in order to achieve the desired objective with the smallest number of resources. Furthermore, the design of the tiles is performed offline and, thus, the tiling is not updated or redesigned as a function of the observed channel estimates for previously used tiles.

Other solutions consider the design of the DCS jointly for both channel estimation and data communication stages. This means that the DCS design during the channel estimation stage could be used directly (or with some minor modifications) for the data communication stage. A progressive DCS design algorithm has been proposed where, with each received pilot, a DCS scattering element is optimized to serve both data and channel estimation stages, while the non-optimized DCS scattering elements are considered as one effective element and are allocated a common phase shift. Nevertheless, this is a per DCS scattering element-based approach and, thus, it may have a slow convergence and may consume a large amount of resources consumption as any conventional scheme that tests only one DCS scattering element at a time.

In view of the above, this disclosure aims to improve current solutions for channel estimation and DCS configuration. An objective is to approach to jointly perform both channel estimation and the DCS phase configuration in a progressive manner, by using one or more sets of scattering elements of the DCS.

This and other objectives are achieved by this disclosure according to the solutions described in the independent claims. Advantageous embodiments are further described in the dependent claims.

A first aspect of this disclosure provides a control entity for a wireless communication system comprising a receiver node, a transmitter node, and a DCS, the DCS comprising a plurality of controllable scattering elements. The control entity is configured to: receive, from the receiver node of the wireless communication system, an estimated direct channel between the transmitter node and the receiver node; determine one or more sets of scattering elements, wherein each set comprises one or more of the plurality of scattering elements; and perform, jointly with the receiver node, a recursive process to: estimate one or more effective concatenated channels between the transmitter node and the receiver node via respectively the one or more sets of scattering elements; and determine a phase configuration for the one or more scattering elements of each of the one or more sets based on the estimated effective concatenated channels and based on the estimated direct channel.

In this disclosure, the terms tile and set are used interchangeably. Further, the terms sub-tile and sub-set are used interchangeably. Further, the terms recursion and iteration are used interchangeably.

In an embodiment of the first aspect, the control entity is further configured to: determine a collection of available sets of scattering elements comprising the one or more sets of scattering elements; receive, from the receiver node, an estimated initial effective concatenated channel between the transmitter node and the receiver node via one or more of the sets of scattering elements; and determine a configuration for each of the plurality of scattering elements based on the estimated initial one or more effective concatenated channels and based on the estimated direct channel.

In an embodiment of the first aspect, the recursive process comprises performing one or more recursions until a stop criterion is met, wherein each recursion comprises: selecting, by the control entity, at least one set of scattering elements from the collection of available sets based on a predefined selection criterion; splitting, by the control entity, the selected at least one set of scattering elements into two or more sub-sets, wherein each sub-set comprises one or more of the scattering elements of the respective at least one selected set; determining, by the control entity, a phase configuration for the one or more scattering elements of each sub-set; and estimating, by the receiver node, two or more new effective concatenated channels via respectively the two or more sub-sets of scattering elements; determining, by the control entity, an updated phase configuration for the scattering elements of each sub-set based on the respective two or more estimated new effective concatenated channels.

Each recursion further comprises: determining, by the receiver node, one or more quality metrics for the two or more sub-sets based on the respective two or more estimated new effective concatenated channels; updating, by the control entity, the collection of available sets based on the determined two or more sub-sets; and determining, by the control entity, whether the predetermined criterion is met based on the one or more quality metrics determined by the receiver node.

In an embodiment of the first aspect, selecting, by the control entity, the at least one set of scattering elements from the collection of available sets based on a predefined selection criterion comprises: selecting a set having a largest number of scattering elements; or selecting the at least one set based on the one or more quality metrics determined in a previous recursion.

In an embodiment of the first aspect, splitting, by the control entity, the selected at least one set of scattering elements into two or more sub-sets comprises: using a predetermined splitting scheme with no prior information of a transmitting node and/or a receiver node of the wireless communication system; or using a splitting scheme comprising prior information of the transmitting node and/or the receiver node of the wireless communication system; or using a random splitting scheme.

In an embodiment of the first aspect, the one or more scattering elements of each of the two or more sub-sets are adjacent or nonadjacent.

In an embodiment of the first aspect, determining by the control entity, a phase configuration for the one more scattering elements of each sub-set comprises adding a phase shift to a phase of the one or more scattering elements of the sub-set.

In an embodiment of the first aspect, updating by the control entity, the collection of available sets based on the determined two or more sub-sets comprises replacing, in the collection of available sets, the selected at least one set with the respective determined two or more sub-sets.

In an embodiment of the first aspect, determining, by the control entity, whether the predetermined criterion is met based on the estimated quality metrics comprises: receiving, from the receiver node, the one or more determined quality metrics for the two or more sub-sets; comparing at least one of the determined quality metrics for the two or more sub-sets with a respective predetermined threshold value; and determining if the predetermined criterion is met based on a result of the comparison.

In an embodiment of the first aspect, the quality metric comprises an Instantaneous Tile-based Reference Signal Received Power (T-RSRP), or a Received Signal Strength (RSS).

A second aspect of this disclosure provides a method for a control entity for a wireless communication system, the wireless communication system comprising a receiver node, a transmitter node, and a DCS, the DCS comprising a plurality of controllable scattering elements. The method comprises: receiving, from the receiver node of the wireless communication system, an estimated direct channel between the transmitter node and the receiver node; determining one or more sets of scattering elements, wherein each set comprises one or more of the plurality of scattering elements; performing, jointly with the receiver node, a recursive process to: estimate one or more effective concatenated channels between the transmitter node and the receiver node via respectively the one or more sets of scattering elements; and determine a phase configuration for the one or more scattering elements of each of the one or more sets based on the estimated effective concatenated channels and based on the estimated direct channel.

In an embodiment of the second aspect, the method further comprises: determining, by the control entity, a collection of available sets of scattering elements comprising the one or more sets of scattering elements; receiving, from the receiver node, an estimated initial effective concatenated channel between the transmitter node and the receiver node via one or more of the sets of scattering elements; and determining a configuration for each of the plurality of scattering elements based on the estimated initial one or more effective concatenated channel and based on the estimated direct channel.

In an embodiment of the second aspect, the recursive process comprises performing one or more recursions until a stop criterion is met, wherein each recursion comprises: selecting, by the control entity, at least one set of scattering elements from the collection of available sets based on a predefined selection criterion; splitting, by the control entity, the selected at least one set of scattering elements into two or more sub-sets, wherein each sub-set comprises one or more of the scattering elements of the respective at least one selected set; determining, by the control entity, a phase configuration for the one or more scattering elements of each sub-set; and estimating, by the receiver node, two or more new effective concatenated channels via respectively the two or more sub-sets of scattering elements; determining, by the control entity, an updated phase configuration for the scattering elements of each sub-set based on the respective two or more estimated new effective concatenated channels.

Each recursion further comprises: determining, by the receiver node, one or more quality metrics for the two or more sub-sets based on the respective two or more estimated new effective concatenated channels; updating, by the control entity, the collection of available sets based on the determined two or more sub-sets; and determining, by the control entity, whether the predetermined criterion is met based on the one or more quality metrics determined by the receiver node.

In an embodiment of the second aspect, selecting, by the control entity, the at least one set of scattering elements from the collection of available sets based on a predefined selection criterion comprises: selecting a set having a largest number of scattering elements; or selecting the at least one set based on the one or more quality metrics determined in a previous recursion.

In an embodiment of the second aspect, splitting, by the control entity, the selected at least one set of scattering elements into two or more sub-sets comprises: using a predetermined splitting scheme with no prior information of a transmitting node and/or a receiver node of the wireless communication system; or using a splitting scheme comprising prior information of the transmitting node and/or the receiver node of the wireless communication system; or using a random splitting scheme.

In an embodiment of the second aspect, the one or more scattering elements of each of the two or more sub-sets are adjacent or nonadjacent.

In an embodiment of the second aspect, determining by the control entity, a phase configuration for the one or more scattering elements of each sub-set comprises adding a phase shift to a phase of the one or more scattering elements of the sub-set.

In an embodiment of the second aspect, updating by the control entity, the collection of available sets based on the determined two or more sub-sets comprises replacing, in the collection of available sets, the selected at least one set with the respective determined two or more sub-sets.

In an embodiment of the second aspect, determining, by the control entity, whether the predetermined criterion is met based on the estimated quality metrics comprises: receiving, from the receiver node, the one or more determined quality metrics for the two or more sub-sets; comparing at least one of the determined quality metrics for the two or more sub-sets with a respective predetermined threshold value; and determining if the predetermined criterion is met based on a result of the comparison.

In an embodiment of the second aspect, the quality metric comprises a T-RSRP, or a RSS.

A third aspect of this disclosure provides a computer program product comprising a program code for carrying out, when implemented on a processor, the method according to the second aspect or its embodiment forms.

The computer program product according to the third aspect comprises the features of the corresponding embodiment forms of the method of the second aspect.

The method according to the second aspect and the computer program product according to the third aspect and their embodiment forms provide the same advantages and effects as described above for the wireless communication system of the first aspect and its respective embodiment forms.

The advantages of the solutions according to the present disclosure can be summarized as follows:
The solutions are progressive, where each received pilot may result in enhancing the DCS configuration. This means that the DCS phase configuration could stop at any moment (or recursion) to allow a data communication phase while benefiting from the already configured DCS achieved during previous recursions.
The solutions may require a reduced number of pilots to achieve the desired objective, hence offering fast convergence and enhanced spectral efficiency possibilities.
The needed number of pilots to achieve the desired objective depends on the scenario at hand, thus, it is adaptive.
The solutions offer the DCS advantages to both data and pilots that are transmitted jointly (e.g., different subcarriers in the same multi-carrier symbol can be allocated).
The solutions offer a flexible tiling that is updated online during the channel estimation procedure as a function of the observed channel estimates.

It has to be noted that all devices, elements, units and means described in the present application could be implemented in the software or hardware elements or any kind of combination thereof. All operations which are performed by the various entities described in the present application as well as the functionalities described to be performed by the various entities are intended to mean that the respective entity is adapted to or configured to perform the respective operations and functionalities. Even if, in the following description of specific embodiments, a specific functionality or operation to be performed by external entities is not reflected in the description of a specific detailed element of that entity which performs that specific operation or functionality, it should be clear for a skilled person that these methods and functionalities can be implemented in respective software or hardware elements, or any kind of combination thereof.

### BRIEF DESCRIPTION OF DRAWINGS

The above described aspects and embodiment forms will be explained in the following description of embodiments in relation to the enclosed drawings, in which

FIG. 1 shows exemplary configurations of DCS scattering surfaces;

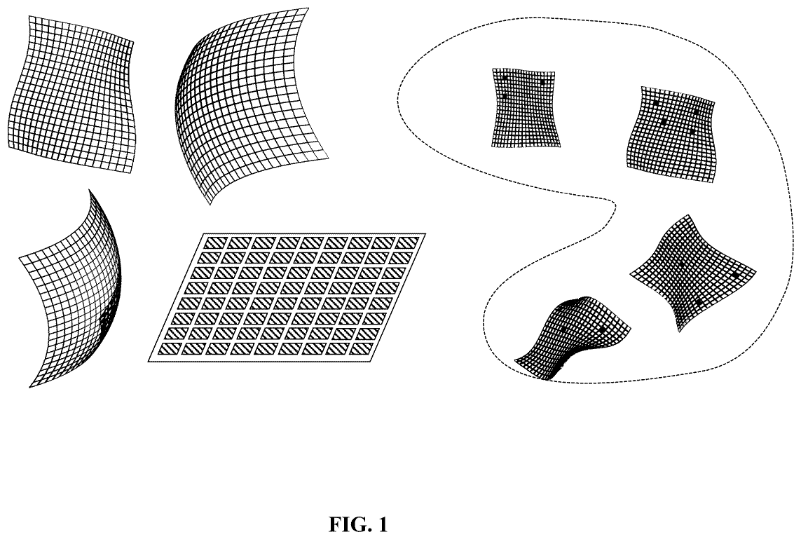

FIG. 2 shows an example of a conventional DCS-aided wireless communication system;

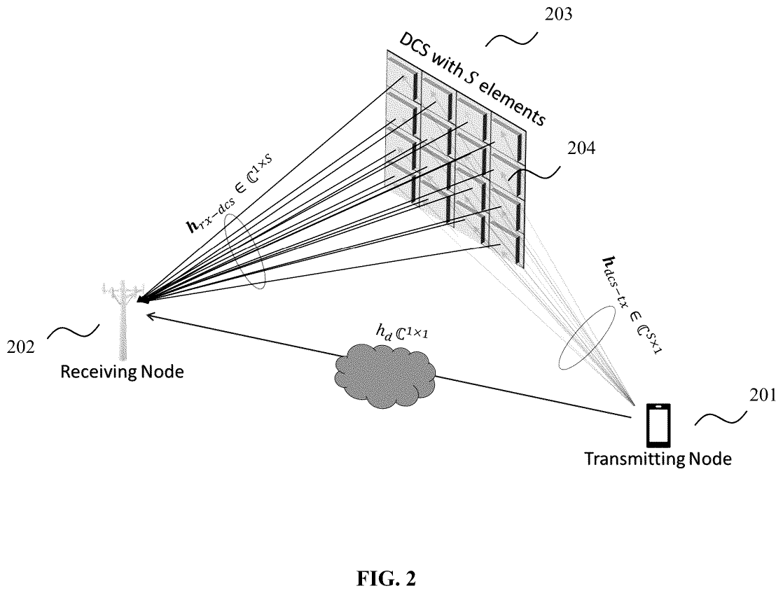

FIG. 3 shows a schematic diagram of a control entity for a wireless communication system according to this disclosure;

FIG. 4 shows an exemplary flowchart for performing a recursive tiling of the scattering elements for channel estimation and DCS configuration according to this disclosure;

FIG. 5a)-b) show exemplary schematic diagrams of the splitting of one or more sub-sets of scattering elements according to this disclosure;

FIG. 6 shows an example of exchanged information between the control entity, a transmitter node, a DCS and a receiver node according to this disclosure; and

FIG. 7 shows a method for a control entity for a wireless communication system according to this disclosure.

### DETAILED DESCRIPTION OF EMBODIMENTS

A list of definitions and notations that are used hereinafter in this description is now provided:
\hat{x} denotes the estimate of x.
Ω denotes a set of indices of the plurality of scattering elements S of the DCS.
Ωᵢ denotes a set of indices of the scattering elements of a set (or tile) i of scattering elements.

$${v}^{H} ( {Ω}_{i} ) = {\underbrace{{e}^{j {σ}_{i}}}}_{{ℂ}^{\vert {Ω}_{i} \vert \times 1}} {\underbrace{{e}^{j {ϕ}_{i}}}}_{{ℂ}^{1 \times 1}} , where j = \sqrt{- 1} ,$$

is a phase vector for the scattering elements in a tile i.
σᵢ corresponds to a vector of unique phases of the set i, where each unique phase is applied to one element of the tile i.
φᵢ corresponds to a common phase that is applied to all the scattering elements of the set i.
α=e^{jσ}h_{b}(Ω) denotes an effective concatenated channel between the transmitter node and the receiver node via the plurality of scattering elements.
αᵢ=e^{jσ}^{ᵢ}h_{b}(Ωᵢ) denotes an effective concatenated channel between the transmitter node and the receiver node via the set i.
   |.| denotes the cardinality (number of elements) of a set of scattering elements.
ζ denotes a collection of available sets of scattering elements.
çᵢ={Ω_{i,1}, Ω_{i,2}, . . . , Ω_{i,N}_{ᵢ}} denotes a set of Nᵢ sub-sets generated during a i-th iteration for channel estimation and configuration at the i-th iteration.

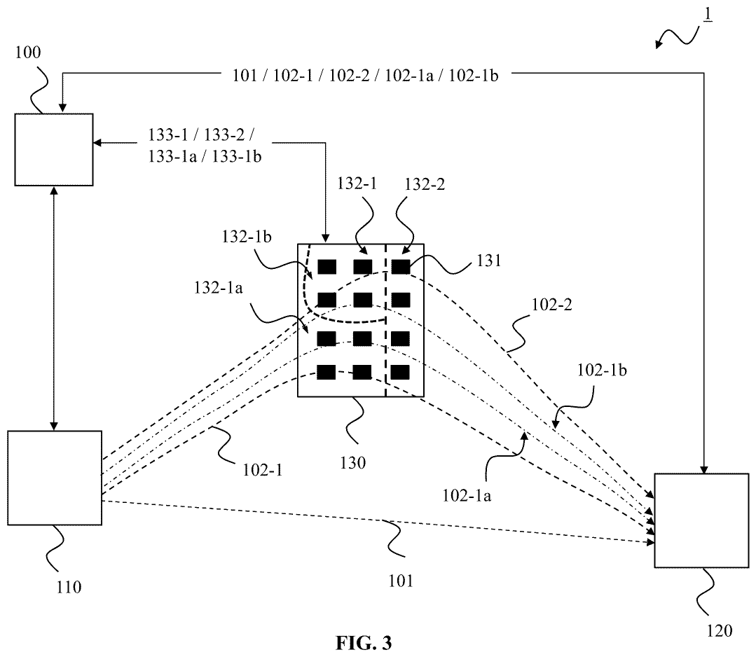

FIG. 3 shows an exemplary embodiment of a control entity 100 for a wireless communication system 1 according to this disclosure. The wireless communication system 1 comprises a receiver node 120, a transmitter node 110, and a DCS 130. The DCS 130 comprises a plurality of scattering elements 131, S, each scattering element 131 having a controllable phase shift. The wireless communication system 1 may further comprise the control entity 100.

The transmitter node 110 may comprise a single transmitter antenna. Alternatively, the transmitter node 110 may comprise multiple transmitter antennas.

The receiver node 120 may comprise a single receiver antenna. Alternatively, the receiver node 120 may comprise multiple receiver antennas.

The transmitter node 110 may be configured to transmit a radiofrequency signal to the receiver node 120. Then, the receiver node 120 may be configured to estimate a direct channel h_{d} 101 between the transmitter node 110 and the receiver node 120.

The control entity 100 is then configured to receive, from the receiver node 120 of the wireless communication system 1, the estimated direct channel h_{d} 101 between the transmitter node 110 and the receiver node 120.

Then, the control entity 100 is configured to determine one or more sets of scattering elements 131, exemplary sets 132-1 and 132-2, and each set 132-1, 132-2 comprises one or more of the plurality of scattering elements 131. Although only two sets 132-1,132-2 are exemplary depicted in FIG. 3, this is not limiting in this disclosure, as more than two sets can be determined by the control entity 100.

That is, the control entity 100 according to this disclosure may group one or more of the scattering elements 131 of the DCS 130, and each resulting group is referred to as a set or tile of scattering elements. This is depicted with an exemplary vertical, dashed line in FIG. 3, where the first exemplary set 132-1 may comprise the scattering elements 131 located at the left side of the dashed line, whereas the second exemplary set 132-2 may comprise the scattering elements 131 located at the right side of said dashed line.

This is only an illustrative example and does not limit this disclosure. In general, the one or more scattering elements 131 of each set 132-1, 132-2 may be adjacent (as in the exemplary sets 132-1, 132-2 depicted in FIG. 3) or may be nonadjacent. Further, the one or more sets 132-1, 132-2 may be adjacent or nonadjacent.

In this disclosure, the terms tile and set are used interchangeably. Further, the terms sub-tile and sub-set are used interchangeably. Further, the terms recursion and iteration are used interchangeably.

Referring back to FIG. 3, the control entity 100 is then configured to perform, jointly with the receiver node 120 and the transmitter node 110, a recursive process in order to estimate one or more effective concatenated channels at 102-1, 102-2 between the transmitter node 110 and the receiver node 120 via respectively the one or more sets Ωᵢ 132-1, 132-2 of scattering elements 131, and to determine a phase configuration 133-1, 133-2 for the one or more scattering elements 131 of each of the one or more sets 132-1, 132-2 based on the estimated effective concatenated channels αᵢ 102-1, 102-2 between the transmitter node 110 and the receiver node 120 via each set Ωᵢ 132-1, 132-2 and based on the estimated direct channel h_{d} 101.

Thereby, the control entity 100 and the receiver node 120 may jointly perform both channel estimation and the DCS phase configuration in a progressive manner, by using the one or more sets Ωᵢ 132-1, 132-2 of scattering elements 131 of the DCS 130.

Before performing the recursive process, the control entity 100 may be configured to perform an initialization phase. In such an initialization phase, the control entity 100 is configured to determine the collection ζ of available sets of scattering elements 131 comprising the one or more sets Ωᵢ 132-1, 132-2. That is, the control entity 100 may construct the collection ζ that comprises the determined one or more sets Ωᵢ 132-1, 132-2 of scattering elements 131, i.e., ζ:{Ωᵢ}. In other words, in this exemplary embodiment, ζ comprises the exemplary sets 132-1, 132-2.

Further, in the initialization phase, the control entity 100 is configured to receive, from the receiver node 120, an estimated initial effective concatenated channel \hat{α}ᵢ between the transmitter node 110 and the receiver node 120 via one or more of the sets Ωᵢ 132-1, 132-2 of scattering elements 131. Then, the control entity 100 is configured to determine a configuration 133-1, 133-2, for each of the plurality of scattering elements 131 in the sets Ωᵢ used to estimate the initial effective concatenated channels \hat{α}ᵢ, based on the estimated initial effective concatenated channels \hat{α}ᵢ between the transmitter node 110 and the receiver node 120 via the one or more of the sets Ωᵢ 132-1, 132-2 and based on the estimated direct channel ĥ_{d} 101.

The recursive process comprises performing one or more recursions until a stop criterion is met. Each recursion comprises the operations explained in the following.

The control entity 100 performs an operation of selecting at least one set 132-1, 132-2 of scattering elements 131 from the collection of available sets ζ based on a predefined selection criterion.

Then, the control entity 100 performs an operation of splitting the selected at least one set Ωᵢ 132-1, 132-2 into two or more sub-sets Ω_{i,N}_{ᵢ}, exemplary sub-sets 132-1a and 132-1b when the set 132-1 is selected. Each sub-set 132-1a, 132-1b comprises one or more of the scattering elements 131 of the respective at least one selected set Ωᵢ 132-1, 132-2.

This is depicted with an exemplary curved, dashed line in FIG. 3, where the first exemplary set Ω₁ 132-1 may be split in the two exemplary sub-sets Ω_{i,1} 132-1a and Ω_{i,2} 132-1b. This is not limiting in this disclosure.

The one or more scattering elements 131 of each of the two or more sub-sets Ω_{i,N}_{ᵢ} 132-1a, 132-1b are adjacent or nonadjacent. Further, the two or more sub-sets Ω_{i,N}_{ᵢ} 132-1a, 132-1b may be adjacent or nonadjacent.

Next, the control entity 100 performs an operation of determining a phase configuration 133-1a, 133-1b for the one or more scattering elements 131 of each sub-set Ω_{i,N}_{ᵢ} 132-1a, 132-1b.

Further, the receiver node 120 performs an operation of estimating two or more new effective concatenated channels 102-1a, 102-1b between the transmitter node 110 and receiver node 120 via respectively each of the two or more sub-sets Ω_{i,N}_{ᵢ} 132-1a, 132-1b of scattering elements 131, denoted as sets α_{i,N}_{ᵢ}.

Next, the control entity 100 performs an operation of determining an updated phase configuration 133-1a, 133-1b for the scattering elements 131 of each sub-set Ω_{i,N}_{ᵢ} 132-1a, 132-1b based on the respective two or more estimated new effective concatenated channels \hat{α}_{i,N}_{ᵢ} 102-1a, 102-1b between the transmitter node 110 and receiver node 120 via respectively the two or more sub-sets Ω_{i,N}_{ᵢ}.

Then, the receiver node 120 performs an operation of determining (or calculating) one or more quality metrics for the two or more sub-sets 132-1a, 132-1b based on the respective two or more estimated new effective concatenated channels \hat{α}_{i,N}_{ᵢ} 102-1a, 102-1b between the transmitter node 110 and receiver node 120 via respectively the two or more sub-sets Ω_{i,N}_{ᵢ}.

The control entity 100 further performs an operation of updating the collection of available sets ζ based on the determined two or more sub-sets Ω_{i,N}_{ᵢ} 132-1a, 132-1b.

Further, the control entity 100 performs an operation of determining whether the predetermined criterion is met based on the one or more quality metrics determined by the receiver node 120. When the predetermined criterion is met, the recursive process stops; otherwise, the above operations are performed again for a next recursion i+1.

In each recursion, the splitting, by the control entity 100, of the selected at least one set Li 132-1, 132-2 of scattering elements 131 into the two or more sub-sets Ω_{i,N}_{ᵢ} 132-1a, 132-1b comprises using a predetermined splitting scheme with no prior information of the wireless communication system 1, i.e., with no prior information of the transmitting node 110 and/or of the receiver node 120 and/or of the DCS 130.

Alternatively, the splitting, by the control entity 100, of the selected at least one set Ωᵢ 132-1, 132-2 of scattering elements 131 into the two or more sub-sets Ω_{i,N}_{ᵢ} 132-1a, 132-1b comprises using a splitting scheme comprising prior information of the transmitting node 110 and/or of the receiver node 120 of the wireless communication system 1, i.e., of the transmitting node 110 and/or of the receiver node 120 and/or of the DCS 130.

Further alternatively, the splitting, by the control entity 100, of the selected at least one set Ωᵢ 132-1, 132-2 of scattering elements 131 into the two or more sub-sets Ω_{i,N}_{ᵢ} 132-1a, 132-1b comprises using a random splitting scheme.

In each recursion, the determining by the control entity 100, a phase configuration 133-1a, 133-1b for the one more scattering elements 131 of each sub-set Ω_{i,N}_{ᵢ} 132-1a, 132-1b comprises calculating a phase shift for the one or more scattering elements 131 of the respective sub-set 132-1a, 132-1b, and subsequently adding the phase shift to a phase configuration for the one or more scattering elements 131 of each sub-set 132-1a, 132-1b.

Further, in each iteration, the updating by the control entity 100, the collection of available sets based on the determined two or more sub-sets 132-1a, 132-1b comprises replacing, in the collection of available sets ζ, the selected at least one set 132-1, 132-2 of scattering elements 131 with the respective determined two or more sub-sets 132-1a, 132-1b. That is, in this exemplary embodiment, the selected set 132-1 is replaced with the two sub-sets 132-1a, 132-1b.

In each recursion, the determining, by the control entity 100, whether the predetermined criterion is met based on the estimated quality metrics comprises receiving, from the receiver node 120, the one or more determined (or calculated) quality metrics for the two or more sub-sets 132-1a, 132-1b using the two or more estimated new effective concatenated channels \hat{α}_{i,N}_{ᵢ} 102-1a, 102-1b between the transmitter node 110 and receiver node 120 via respectively each sub-set Ω_{i,N}_{ᵢ}. Then, the control entity 100 compares at least one of the determined quality metrics with a respective predetermined threshold value. Further, the control entity 100 determines if the predetermined criterion is met based on a result of the comparison.

In this exemplary embodiment, each of the one or more quality metrics comprises, for example and not as a limitation, an Instantaneous Tile-based Reference Signal Received Power (T-RSRP), or a Received Signal Strength (RSS), or a signal to noise ratio (SNR), or the like.

The control entity 100 according to this disclosure may be implemented in, or may be part of, the DCS 130. For example, the DCS 130 may further comprise a controller, and the control entity 100 according to this disclosure may be implemented in, or may be part of, the DCS controller. Alternatively, the control entity 100 may be implemented as a separate entity (as depicted in FIG. 3), and may be part of the wireless communication system 1.

The control entity 100 may be further configured to send, by signaling, to the DCS 130 the determined one or more sets Ωᵢ 132-1, 132-2 of scattering elements 131 used in each recursion. Additionally or alternatively, the control entity 100 may be configured to send, by signaling, to the DCS 130 the one or more sub-sets Ω_{i,N}_{ᵢ}. 132-1a, 132-1b constructed in each iteration i. Further additionally or alternatively, the control entity 100 may be configured to send, by signaling, to the DCS 130 the phase configurations 133-1, 133-2 for the one or more scattering elements 131 of each of the one or more sets Ωᵢ 132-1, 132-2 and/or the phase configurations 133-1a, 133-1b for the one or more scattering elements 131 of each sub-set Ω_{i,N}_{ᵢ} 132-1, 132-2, determined in each recursion i.

The receiver entity 120 may be configured to send, by signaling, to the control entity 100 the estimated direct channel ĥ_{d} 101 between the transmitter node 110 and the receiver node 120 and the one or more estimated initial effective concatenated channels \hat{α}ᵢ between the transmitter node 110 and the receiver node 120 via the one or more sets Ωᵢ 132-1, 132-2 of scattering elements 131.

Further, the receiver entity 120 may be configured to send, by signaling, to the control entity 100 the two or more new effective concatenated channels \hat{α}_{i,N}_{ᵢ} 102-1a, 102-1b via respectively the two or more sub-sets Ω_{i,N}_{ᵢ} 132-1a, 132-1b of scattering elements 131 estimated in each recursion i.

The receiver entity 120 may be further configured to send, by signaling, to the control entity 100 the one or more quality metrics determined in each recursion i.

Thereby, in this embodiment, the control entity 100 may be able to design the phase configuration of the DCS 130 for joint channel estimation and data communication via a progressive tiling of the scattering elements 131 of the DCS 130. Further, the tiling is performed in the recursive manner disclosed above, where during each recursion:
At least one tile is selected and is split into at least two sub-tiles. This leads to (i) reducing the size of the new tiles, thus, enhancing the resulting accuracy, and (ii) increasing the set of available tiles by at least one tile.
The phases of the DCS elements of the new tiles are updated.

The tile selection, splitting, and phase update operations disclosed above require some channel-based metrics that are determined (or estimated) during the recursion process. The recursion process stops once the predefined stop criterion is satisfied. This results in an adaptive feature where the desired accuracy, convergence speed, and processing efforts of the wireless communications system 1 are tunable.

In other words, and based on a desired objective and the given scenario, the exemplary embodiment for the control entity of FIG. 3 may be capable of converge after a few recursions only, thus offering high efficiency represented by the need for a small number of pilots and processing resources.

The control entity 100 according to this disclosure may comprise a processor or processing circuitry (not shown) configured to perform, conduct or initiate the various operations of the device 100 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors. The control entity 100 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the control entity 100 to be performed. The processing circuitry may comprise one or more processors and a non-transitory memory connected to the one or more processors. The non-transitory memory may carry executable program code which, when executed by the one or more processors, causes the control entity 100 to perform, conduct or initiate the operations or methods described herein.

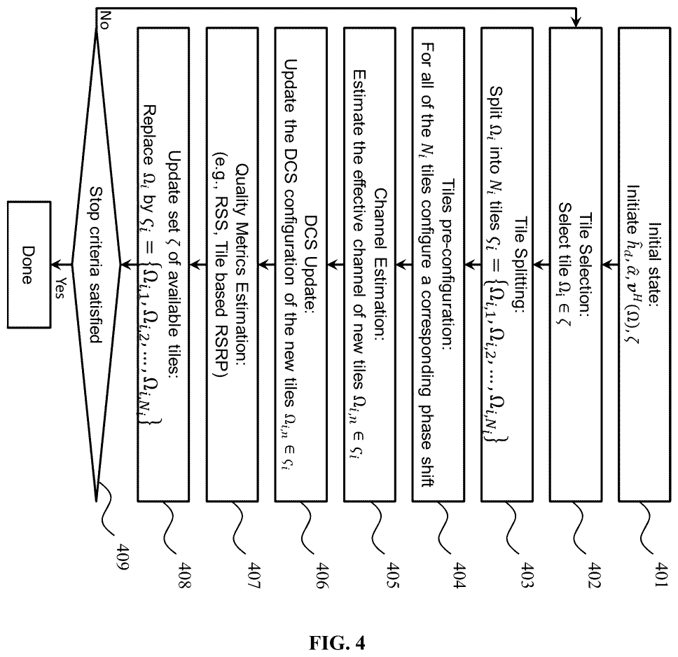

FIG. 4 shows an exemplary flow diagram for the above-disclosed features of the exemplary embodiment of the control entity 100 of FIG. 3 according to this disclosure.

In operation 401, the control entity 100 may perform the initialization phase. In the initialization phase, the receiver node 120 may be configured to estimate the one or more initial effective concatenated channel \hat{α}ᵢ between the transmitter node 110 and the receiver node 120 via the one or more sets 132-1, 132-2 of scattering elements 131, and may further send it to the control entity 100.

For example and not as a limitation, the initial effective concatenated channel between the transmitter node 110 and the receiver node 120 may be via the plurality of scattering elements 131, denoted by a, which may be estimated along with the direct channel using, for example, after the transmitter node 110 transmits two first pilots that are received by the receiver node 120.

This can be achieved, for example and not as a limitation, by setting two distinguishable phase rotations for a common phasor ø of the DCS 130 regardless of a configuration given by a phase vector σ of the plurality of scattering elements 131 of the DCS 130.

In this exemplary embodiment, a first pilot transmission can be performed after configuring, by the control entity 100, the common phasor as e^{jφ}=e^{jγ} with γ∈[0,2π[. A second pilot transmission can be performed after configuring, by the control entity 100, the plurality of scattering elements 131 of the DCS 130 with a rotated version, where the rotation is given by e^{jφ}=e^{jδ}, with δ∈[0,2π[≠γ.

Then, the control entity 100 may configure the plurality of scattering elements 131 of the DCS 130 using the estimated initial effective concatenated channel \hat{α} between the transmitter node 110 and the receiver node 120 via the plurality of scattering elements 131, denoted by Ω.

Further, the control entity 100 may initialize the collection ζ of available sets with Ω, thus ζ:{Ω}.

This initialization phase 401 may also comprise receiving, by the control entity 100 from the receiver node 120, the estimated direct channel ĥ_{d} between the transmitting node 110 and the receiver node 120.

After the initialization phase 401, the control entity 100 may be configured to perform, jointly with the receiver node 120 and the transmitter node 110, the recursive process.

The recursive process may comprise operation 402 of tile selection. That is, in each recursion i the control entity 100 may select at least one set Ωᵢ∈ζ of scattering elements 131 from the collection of available sets ζ, where Ωᵢ represents the selected set during the i-th recursion. The selection is based on the predefined selection criterion as explained above.

Then, the recursive process may comprise operation 403 of tile splitting. That is, the control entity 100 may divide each of the at least one selected set Ωᵢ of operation 402 into Nᵢ sub-sets çᵢ={Ω_{i,1}, Ω_{i,2}, . . . , Ω_{i,N}_{ᵢ}}, where each sub-set Ω_{i,N}_{ᵢ} may be a group of the one or more scattering elements 131 comprised in the selected set Ωᵢ.

Each sub-set can be constructed following a predefined scheme or can be selected randomly among Ωᵢ. The one or more scattering elements 131 in each sub-set can be adjacent or can be nonadjacent. Further, the Nᵢ sub-sets can be adjacent or can be nonadjacent.

The recursive process may comprise a further operation 404 of DCS pre-configuration. In this operation, the one or more scattering elements 131 in each sub-set Ω_{i,1}, Ω_{i,2}, . . . , Ω_{1,N}_{ᵢ} may be pre-configured and prepared for a next operation 405 of channel estimation. The pre-configuration operation may comprise calculating and adding a phase shift φ_{i,n} to the phases of the one or more scattering elements 131 of each sub-tile n, with n∈1, . . . , Nᵢ, i.e., the sub-tiles Ω_{i,1}, Ω_{i,2}, . . . , Ω_{i,N}_{ᵢ}.

Thus, the one or more scattering elements 131 in the sub-set Ω_{i,n} are applied a phase rotation of φ_{i,n}.

In an exemplary embodiment, a collection of tiles νᵢ⊂çᵢ containing at least one of the sub-sets Ω_{i,n} may have their phases shifted, while the phases of the remaining sub-sets (ζ−Ωᵢ)∪(çᵢ−ξᵢ) may remain unchanged, e.g. the added phase shift for those sub-tiles may be selected as being equal to 0.

The phase shift din determined by the control entity 100 may be the same for all of the one or more scattering elements 131 of each sub-set 132-1a, 132-1b. Alternatively, the phase shift φ_{i,n} may not be applied the same to all the scattering elements 131 of each sub-set 132-1a, 132-1b, but a phase shift \tilde{φ}_{i,n}(s) where s is the index of the scattering element can be applied to each scattering element 131 in each subset 132-1a, 132-1b as a function of the scattering element 131, for example a phase shift \tilde{φ}_{i,n}(s)=φ_{i,n}+μ(s), where the phase shift applied to a scattering element s is a function of both φ_{i,n} (i.e., the common phase) and the scattering element s, where μ(.) can be a function representing, for example, a phase pattern. Such kind of embodiments could be foreseen and useful if, for example, the radiofrequency signal sent by the transmitter node 110 comprises a planar wave. Alternatively, other function of \tilde{φ}_{i,n}(s) can be considered when the radiofrequency signal comprises a spherical wave.

Further, the recursive process may comprise the operation 405 of channel estimation. In this operation, an end-user (or receiver node 120) may receive a training for the i-th recursion, which may contain at least one pilot signal. The received training may be used to estimate two or more new effective concatenated channels din between the transmitter node 110 and the receiver node 120 via respectively the two or more sub-sets, \hat{α}_{i,n}=e^{Jσ}^{_{i,n}} [symbol] Ω_{i,n}) ∀n∈1, . . . , Nᵢ.

Next, the recursive process may comprise operation 406 of DCS configuration. In this operation, the one or more new effective concatenated channels

$${\{ {\hat{α}}_{i , n} \}}_{n ∈ 1 , … , {N}_{i}}$$

between the transmitter node 110 and the receiver node 120 via respectively the two or more sub-sets Ω_{i,n}, estimated in operation 405, may be used to configure the scattering elements 131 of the sets Ωᵢ,∈çᵢ respectively.

The recursive process may comprise a further operation 407 of quality metric estimation, where the receiver node 120 (or end-user) may determine the one or more quality metrics for the two or more sub-sets based on the respective two or more estimated new effective concatenated channels \hat{α}_{i,n} between the transmitter node 110 and the receiver node 120 via respectively the two or more sub-sets Ω_{i,N}_{ᵢ} and based on the updated configuration for the one or more scattering elements of the sub-sets Ω_{i,n}.

Further, the recursive process may comprise operation 408 of updating the available tiles. That is, the collection of available sets ζ may be updated, by the control entity 100, with the sub-tiles Ω_{i,n}∈çᵢ; n=1 . . . Nᵢ. In other words, Ωᵢ is replaced with all subsets in çᵢ, as given in Equation (2):

$$\{ \begin{matrix}ζ := ζ - {Ω}_{i} \\ ζ := ζ ⋃ {ς}_{i}\end{matrix} \qquad ( 2 )$$

Thus, after Nₚ recursions, the collection ζ of available sets of scattering elements 131 may have

$$\vert {ζ}_{0} \vert + {\sum }_{i = 1}^{{N}_{p}} ( \vert {ς}_{i} \vert - 1 )$$

tiles, where ζ₀ an initial set of tiles.

The recursive process may further comprise operation 409 of determining whether to continue with the recursion process or not. In this operation, the control entity 100 may receive, from the receiver node 120, the one or more determined quality metrics for the two or more sub-sets Ω_{i,N}_{ᵢ} by using the estimated two or more effective concatenated channels \hat{α}_{i,N}_{ᵢ} 102-1a, 102-1b between the transmitter node 110 and receiver node 120 via respectively the two or more sub-sets Ω_{i,N}_{ᵢ}. Then, the control entity 100 can compare at least one of the determined quality metrics with a respective predetermined threshold value, and can further determine, based on the result of the comparison, whether the predetermined criterion is met.

If the predetermined criterion is met, the recursive process is successfully finished. Otherwise, the recursive process may continue with the next iteration, and the above-explained operations 402 to 409 may be performed again.

It is to be noted that through the proposed recursive and incremental configuration of the DCS 130, this disclosure enables a live adaptation of the DCS 130 to the acquired partial channel propagation conditions. In addition, a partial channel information acquired through the successive recursions can also be used to derive the channel estimates, if needed. This can be considered as a secondary output of the scheme according to this disclosure.

In the following, an exemplary embodiment of the features of the control entity 100 of FIG. 3 and the operations of the exemplary flow chart shown in FIG. 4 are presented for illustrative purposes.

In this example, for the initialization phase, the direct channel h_{d} and the initial effective concatenated channel between the transmitter node 110 and the receiver node 120 via the plurality of scattering elements 131 of the DCS, α, may be estimated by using the first two pilots transmitted by the transmitting node 110.

Before the arrival of the first pilot x₁, the control entity 100 may configure the phase vector σ for the plurality of scattering elements as a zero vector, given in Equation (3):

$$σ = {\underbrace{[ 0 , 0 , ... , 0 ]}}_{1 \times S} . \qquad ( 3 )$$

Further, the control entity 100 may configure a common phase φ for the DCS 130 as φ=θ+π, where θ is a predefined phase that may correspond to an initial or previous knowledge of a propagation environment.

Thus, a noiseless signal received by the receiver node 120 of the transmitted first pilot is written in Equation (4):

$${y}_{1} = ( - α {e}^{j θ} + {h}_{d} ) {x}_{1} , \qquad ( 4 )$$

where α denotes the initial effective concatenated channel between the transmitter node 110 and the receiver node 120 via the plurality of scattering elements 131 of the DCS 130, i.e., α=e^{jσ}h_{b}(Ω).

In an embodiment, for a second pilot x₂, the control entity 100 may configure the phase vector σ for the plurality of scattering elements 131 as the zero-vector given in Equation (3), and may further configure the common phase φ for the plurality of scattering elements to have an opposite phase shift, i.e., φ=θ.

This configuration has been chosen in this example for simplifying the channel estimation and not as a limitation, as the required linear combination becomes simple summations and subtractions, as explained later in this disclosure.

The noiseless received signal by the receiver node 120 of the second transmitted pilot can thus be written as in Equation (5):

$${y}_{2} = ( α {e}^{j θ} + {h}_{d} ) {x}_{2} , \qquad ( 5 )$$

Using Equation (4) and Equation (5), the direct channel h_{d} between the transmitter node 110 and the receiver node 120 and the effective concatenated channel α between the transmitter node 110 and the receiver node 120 via the plurality of scattering elements 131 can be estimated as in Equations (6) and (7):

$${\hat{h}}_{d} = \frac{1}{2} ( \frac{{y}_{2}}{{x}_{2}} + \frac{{y}_{1}}{{x}_{1}} ) , \qquad ( 6 )$$

$$\hat{α} = \frac{1}{2 {e}^{j θ}} ( \frac{{y}_{2}}{{x}_{2}} - \frac{{y}_{1}}{{x}_{1}} ) . \qquad ( 7 )$$

Using the estimated channels in Equations (6) and (7), a common phase for the DCS can be configured, for example, to align with the (estimated) direct channel ĥ_{d} as shown in Equation (8):

$$ϕ = exp ( - ∠ \hat{α} + ∠ {\hat{h}}_{d} ) . \qquad ( 8 )$$

The control entity 100 may then perform, jointly with the receiver node 120, the recursive process. In each recursion, the control entity 100 may select at least one of the sets of scattering elements 131 from the collection ζ of available sets based on the predefined selection criterion.

For example and not as a limitation, the predefined selection criterion may be based on acquired prior information of the wireless communication system 1 (i.e., on acquired prior information of the transmitter node 110 and/or the receiver node 120 and/or the DCS 130) may comprise:
1) Selecting the set with the largest number of scattering elements 131, or
2) Selecting the set as a function of the one or more quality metrics that are determined (or calculated) in a previous recursion, for example the T-RSRP metric or the RSS metric as disclosed above, which in turn may be calculated by using the two or more new effective concatenated channels \hat{α}_{i,N}_{ᵢ} between the transmitter node 110 and receiver node 120 via respectively the two or more sub-sets Ω_{i,N}_{ᵢ} estimated in the previous recursion.

Then, the recursive process comprises the operation of splitting, by the control entity 100, the selected at least one set Ωᵢ into two or more sub-sets. In this example, and not as a limitation, it is considered that Nᵢ=2. That is, hereinafter in this example, the control entity 100 may split the at least one selected set 22; into two disjoint and complementary sub-sets Ω_{i,1} and Ω_{i,2}, i.e., Ω_{i,1} and Ω_{i,2} are chosen according to Equation (9):

$$\{ \begin{matrix}{Ω}_{i , 1} ⋂ {Ω}_{i , 2} = ∅ \\ {Ω}_{i , 1} ⋃ {Ω}_{i , 2} = {Ω}_{i}\end{matrix} . \qquad ( 9 )$$

In each recursion, a different splitting schemes may be used. For example, the splitting scheme used in each recursion i may comprise:
1) A predetermined splitting sequence with no prior information of the wireless communication system 1, e.g., information of the transmitter node 110 and/or the receiver node 120 and/or the DCS 130, such as a rectangular based split, or a non-continuous based split, or
2) A splitting scheme comprising prior information of the wireless communication system 1, e.g., information of the transmitter node 110 and/or the receiver node 120 and/or the DCS 130 where some rough prior knowledge of the communicating nodes (for example localization, distance, or the like) can be used to adapt the splitting scheme so that an effective concatenated channel α_{i,N}_{ᵢ} between the transmitter node 110 and the receiver node 120 via a respective sub-set Ω_{i,N}_{ᵢ} may have a similar contribution. This reinforces the common phase attribution that the plurality of scattering elements 131 of the same set may have; or
3) A random splitting scheme.

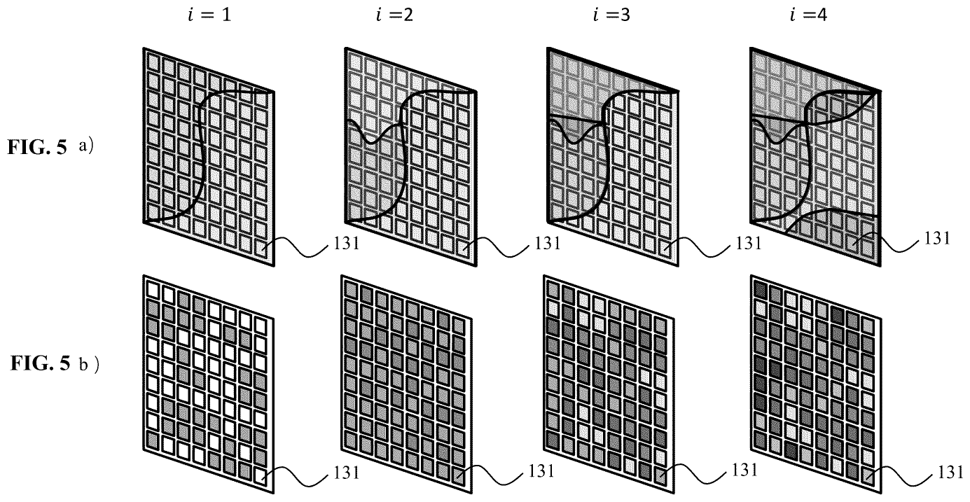

FIGS. 5a) and 5b) depict two illustrative examples of the splitting of the at least one set of scattering elements performed in the first four recursions, i.e., for i=1, 2, . . . , 4. The first example, shown in FIG. 5a) may comprise splitting the two sets Ω_{i,N}_{ᵢ} of scattering elements 131 along continuous lines, resulting in one or more regions, where each region is subdivided into two regions. Further, each recursion may comprise a mapping operation performed by the control entity 100 where each of the scattering elements in each set may be identified through inclusion in the constructed regions.

The second example, shown in FIG. 5b) may comprise a discrete splitting scheme where, at each recursion, two random sub-sets Ω_{i,N}_{ᵢ} may be selected within the at least one selected set Ωᵢ to constitute the two sub-sets obtained Ω_{i,1} and Ω_{i,2} in each recursion.

Referring again to the example with Nᵢ=2 sub-sets of scattering elements 131, where the two sub-sets Ω_{i,1} and Ω_{i,2} have been obtained, the recursion process may further configure the phase configuration for said two sub-sets Ω_{i,1}, Ω_{i,2}. As disclosed for the initialization phase, an embodiment may consist in configuring a common phase for the scattering elements 131 of each sub-set Ω_{i,1} and Ω_{i,2}. For example, and not as a limitation, the common phases for the two sub-sets may be configured as antipodes of each other, e.g., φ_{i,1}=φ_{i,2}+π=φᵢ, where φ_{i,1} is a vector with the common phases for the one or more scattering elements 131 of the sub-set Ω_{i,1}, φ_{i,2} is a vector with the common phases for the one or more scattering elements 131 of the sub-set Ω_{i,2}, and φᵢ is a vector with the common phases for the one or more scattering elements 131 of the set Ωᵢ from which the two sub-sets originate.

An embodiment example may be as follows. The common phase of the smallest sub-tile (where in terms of a number of elements 131 comprised in each sub-set Ω_{i,N}_{ᵢ}) to be the antipode of the biggest sub-tile, so that the common phase of the biggest sub-tile remains unchanged. Thus, if the biggest sub-tile is Ω_{i,1}, i.e., |Ψ_{i,1}|>|Ω_{i,2}|, then the control entity 100 may configure the common phase of the (smallest) sub-tile Ω_{i,2} as in Equation (10):

$${ϕ}_{i , 2} = {ϕ}_{i} + π , \qquad ( 10 )$$

where φᵢ denotes the common phase attributed to the set Ωᵢ during a previous recursion. The common phase of the biggest sub-set Ω_{i,1} may remain unchanged and can be given, for example, in Equation (11):

$${ϕ}_{i , 1} = {ϕ}_{i} . \qquad ( 11 )$$

Then, after the pre-configuration operation in which the two sub-sets Ω_{i,1} and Ω_{i,2} have been configured with opposite common phases φᵢ and (φᵢ+π) respectively, a k-th pilot signal received by the receiver node 120 may be written as Equation (12):

$${y}_{k} = ( {e}^{{j ϕ}_{i}} {\underbrace{( {α}_{i , 1} - {α}_{i , 2} )}}_{β} + {\sum }_{\begin{matrix}j ∈ ζ \\ j \neq i\end{matrix}} {e}^{{j ϕ}_{j}} {α}_{j} ) {x}_{k} + {η}_{k} . \qquad ( 12 )$$

In this example, during a previous recursion, the summation of the two effective concatenated channels between the transmitter node 110 and the receiver node 120 via respectively each of the sub-sets may be calculated as αᵢ=α_{i,1}+α_{i,2}. During a current recursion, the two effective concatenated channels α_{i,N}_{ᵢ} via respectively each of the sub-sets Ω_{i,N}_{ᵢ} may be estimated, by the receiver node 120, by calculating their difference, i.e., β=α_{i,1}−α_{i,2}. Different exemplary embodiments to estimate the two effective concatenated channels α_{i,N}_{ᵢ} via respectively the two sub-sets obtained in a current recursion i are presented below.
Example 1: An effective concatenated channel ai between the transmitter node 110 and the receiver node 120 via respectively each of the sets Ωᵢ comprised in the collection ζ of available sets can be estimated. Then, said estimated effective concatenated channels ai between the transmitter node 110 and the receiver node 120 via respectively each of the sets Ωᵢ may be used to calculate the quantity

$${\sum }_{\begin{matrix}j ∈ ζ \\ j \neq i\end{matrix}} {e}^{{j ϕ}_{j}} {\hat{α}}_{j} .$$

Further, the receiver node 120 may calculate

$$β as \hat{β} = \frac{1}{{e}^{{j ϕ}_{i}}} ( \frac{{y}_{k}}{{x}_{k}} - {\sum }_{\begin{matrix}j ∈ ζ \\ j \neq i\end{matrix}} {e}^{{j ϕ}_{j}} {\hat{α}}_{j} ) .$$

Next, the receiver node 120 may estimate the effective concatenated channel α_{i,N}_{ᵢ} between the transmitter node 110 and the receiver node 120 via respectively the two sub-sets Ω_{i,N}_{ᵢ} as follows:

$${\hat{α}}_{i , 1} = \frac{{\hat{α}}_{i} + \hat{β}}{2} and {\hat{α}}_{i , 2} = \frac{{\hat{α}}_{i} - \hat{β}}{2} .$$

Example 2: This exemplary embodiment may add constraints on the tile selection operation with the objective of reducing the propagated error. In this example, the set Ωᵢ selected in two consecutive recursions should not be correlated, that is, Ωᵢ∩Ωᵢ₋₁=Ø.

Then, in a previous recursion i−1, the selected set Ωᵢ₋₁ may be divided into the two sub-sets Ω_{i-1,1} and Ω_{i-1,2} while the selected set at the recursion i, Ωᵢ, may be divided into the two sub-sets Ω_{i,1} and Ω_{i,2}. Thus, the signal received at the receiver node 120 at the (i−1)-th and i-th recursions can be written as in Equations (13) and (14), respectively:

$${y}_{k - 1} ( {e}^{{j ϕ}_{i}} ( {α}_{i , 1} + {α}_{i , 2} ) + {e}^{{j ϕ}_{i - 1}} ( {α}_{i - 1 , 1} - {α}_{i - 1 , 2} ) + {\sum }_{\begin{matrix}j ∈ ζ \\ j \neq i , i - 1\end{matrix}} {e}^{{j ϕ}_{j}} {α}_{j} ) {x}_{k - 1} + {η}_{k - 1} \qquad ( 13 )$$

$${y}_{k} ( {e}^{{j ϕ}_{i}} ( {α}_{i , 1} + {α}_{i , 2} ) + ( {e}^{{j ϕ}_{i - 1 , 1}} {α}_{i - 1 , 1} + {e}^{{j ϕ}_{i - 1 , 2}} {α}_{i - 1 , 2} ) + {\sum }_{\begin{matrix}j ∈ ζ \\ j \neq i , i - 1\end{matrix}} {e}^{{j ϕ}_{j}} {α}_{j} ) {x}_{k} + {η}_{k} . \qquad ( 14 )$$

Further, the receiver node 120 may calculate a difference between the received signal of the last two recursions as in Equation (15):

$$\frac{{y}_{k - 1}}{{x}_{k - 1}} - \frac{{y}_{k}}{{x}_{k}} = 2 {e}^{{j ϕ}_{i}} {α}_{i , 2} + {α}_{i - 1 , 1} ( {e}^{{j ϕ}_{i - 1}} - {e}^{{j ϕ}_{i - 1 , 1}} ) - {α}_{i - 1 , 2} ( {e}^{{j ϕ}_{i - 1}} + {e}^{{j ϕ}_{i - 1 , 2}} ) + {\tilde{η}}_{k - 1} + {\tilde{η}}_{k} , \qquad ( 15 )$$

where

$${\tilde{η}}_{k - 1} = \frac{{\tilde{η}}_{k - 1}}{{x}_{k - 1}} and {\tilde{η}}_{k} = \frac{{η}_{k}}{{x}_{k}} .$$

From Equation (15), it is noted that the additive interference term may be reduced only to two previously estimated effective concatenated channels between the transmitter node 110 and the receiver node 120 via respectively the two previously determined sub-sets. Then, the effective concatenate channel α_{i,2} between the transmitter node 110 and the receiver node 120 via the sub-set Ω_{i,2} can be estimated and is given in Equation (16):

$${\hat{α}}_{i , 2} = \frac{1}{2 {e}^{{j ϕ}_{i}}} ( \frac{{y}_{k - 1}}{{x}_{k - 1}} - \frac{{y}_{k}}{{x}_{k}} ) - ( {\hat{α}}_{i - 1 , 1} ( {e}^{{j ϕ}_{i - 1}} - {e}^{{j ϕ}_{i - 1 , 1}} ) - {\hat{α}}_{i - 1 , 2} ( {e}^{{j ϕ}_{i - 1}} + {e}^{{j ϕ}_{i - 1 , 2}} ) ) , \qquad ( 16 )$$

and the effective concatenated channel α_{i,1} between the transmitter node 110 and the receiver node 120 via the other sub-set, Ω_{i,1} can be estimated as in Equation (17):

$${\hat{α}}_{i , 1} = {\hat{α}}_{i} - {\hat{α}}_{i , 2} . \qquad ( 17 )$$

Next, for the example with Nᵢ=2, the recursive process may further comprise the operation of updating the DCS configuration. That is, the control entity 100 may configure the scattering elements 131 of the DCS 130 using the two effective concatenated channels \hat{α}_{i,1} and \hat{α}_{i,2} between the transmitter node 110 and the receiver node 120 via respectively the two sub-sets Ω_{i,1} and Ω_{i,2}, which have been estimated in the previous operation (see Equations (16) and (17) above), and using the estimated direct channel ĥ_{d} calculated during the initialization phase.

For example and not as a limitation, the one or more scattering elements 131 in each sub-set Ω_{i,N}_{ᵢ} may be configured to optimize one of quality metrics, for example to maximize the SNR at the end-user (or receiver node) 120. To this end, the common phase for the one or more scattering elements 131 in each sub-set Ω_{i,1} and Ω_{i,2} may be configured respectively as in Equations (18) and (19):

$${e}^{{j ϕ}_{i , 1}} = exp ( j ( - ∠ {\hat{α}}_{i , 1} + ∠ {\hat{h}}_{d} ) ) , \qquad ( 18 )$$

$${e}^{{j ϕ}_{i , 2}} = exp ( j ( - ∠ {\hat{α}}_{i , 2} + ∠ {\hat{h}}_{d} ) ) . \qquad ( 19 )$$

In the next operation, the receiver node 120 may estimate the one or more quality metrics. Said quality metrics may be used in different operations of the recursive process, as disclosed above.

For example and not as a limitation, the T-RSRP quality metric for each sub-set Ω_{i,N}_{ᵢ} may be calculated at each recursion i (that is, an instantaneous T-RSRP) using the effective concatenated channels \hat{α}_{i,1} and \hat{α}_{i,2} via the respective sub-sets Ω_{i,1} and Ω_{i,2} that have been estimated in that recursion, as given in Equation (20):

$$Instantaneous T - R {SRP}_{i , 1} = {\vert {\hat{α}}_{i , 1} \vert}^{2} , \qquad ( 20 )$$

$$Instantaneous T - R {SRP}_{i , 2} = {\vert {\hat{α}}_{i , 2} \vert}^{2}$$

In another example, the RSS can be defined as a linear average of total received power until the reception of a k-th pilot and the corresponding updated configuration for the one or more scattering elements 131, and is given in Equation (21):

$$RSS = \frac{1}{τ} {\sum }_{t = k - τ + 1}^{k} {\vert {y}_{t} \vert}^{2} , \qquad ( 21 )$$

where τ is an average window.

Next, the recursive process may comprise the operation of updating the collection of available sets ζ from which a set is selected at the beginning of each recursion. For the example with Nᵢ=2, the tile Ωᵢ selected at the first operation of the recursion process may be replaced in the collection ζ of available tiles with the sub-sets Ω_{i,1}, Ω_{i,2}. Thereby, the set ζ of available tiles after receiving Nₚ≥2 pilots may be ζ: {Ω₁, Ω₂, . . . , Ω_{(N}_{_{P}}₋₁₎}.

Further in this example, the recursion process may comprise the operation of verifying whether the stop criteria are satisfied. The control entity 100 may compare at least one of the quality metrics disclosed above with a predefined threshold in order to decide whether to continue with the recursive process, or to stop it.

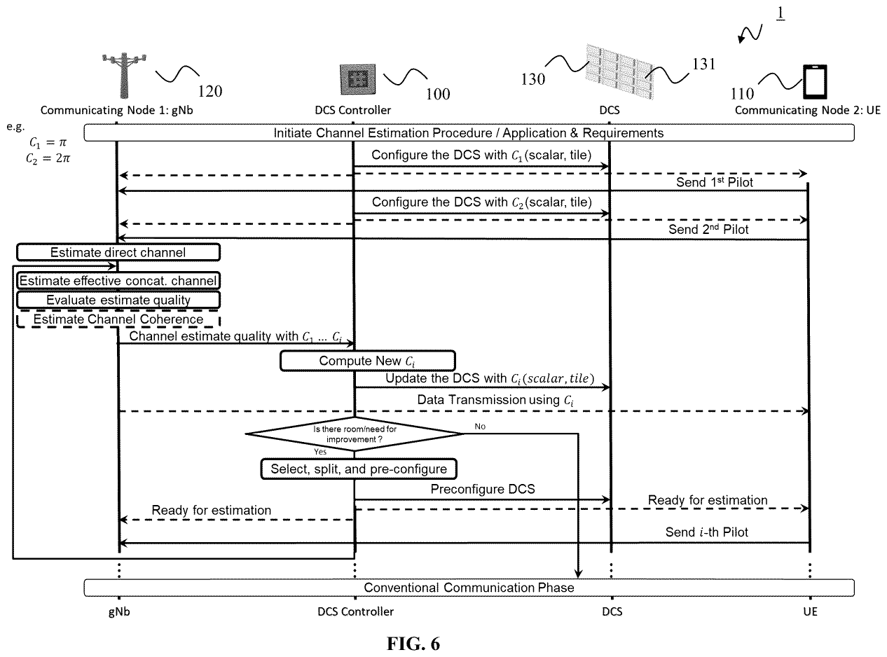

FIG. 6 shows an example of exchanged signaling in the wireless communication system 1 according to this disclosure. Same elements are labelled with the same reference signs.

In this example, the control entity 100 is assumed to be implemented in the DCS controller, and, without loss of generality, the receiver node 120 may be represented as a base station (BS or gNB in FIG. 6) and the transmitter node 110 may be represented as a user equipment (UE).

In the example of FIG. 6, no prior information of the wireless communication system 1 may be considered. The control entity 100 may perform the initialization phase where the collection of available sets ζ comprising one or more sets of scattering elements 131 may be determined. The scattering elements 131 in at least one of the sets may be configured twice with opposite phases as a whole. Then, the control entity 100 may inform the DCS the configuration phase of the scattering elements 131 of each set. That is, the DCS controller 100 (or control entity 100) may inform the DCS 130 each of the phase configurations to be applied as well as the one or more scattering elements 131 comprised in the sets. This is depicted in FIG. 6 as C₁ (scalar, tile) and C₂ (scalar, tile), where C₁=π and C₂=2π are the two opposite phases mentioned above.

Subsequently, the control entity 100 may send the UE 110, by signaling, a request for pilot transmission.

In an embodiment, signaling can also be addressed to the BS 120 (or receiver node 120). Then, the first and second pilots are emitted by the UE 110 and the direct channel between the transmitter node 110 and the receiver node 120 may be estimated by the BS 120. Additionally, the initial effective concatenated channel between the transmitter node 110 and the receiver node 120 via one of the sets can be estimated by the receiver node 120.

Further, the BS 120 may determine a quality metric for one or more effective concatenated channels between the transmitter node 110 and the receiver node 120 via at least one of the sets. Then, the BS 120 may feed back the estimated information to the DCS controller 100 through signaling. The information fed back from the BS 120 to the control entity 100 can comprise the full estimates and/or the computed (or determined) quality metric. The level and amount of fed back information may depend on the available resources and predefined decision quantities.

In addition, after the one or more direct and effective concatenated channels are acquired, an extra communication can happen for data exchange with the actual (intermediate) configuration Cᵢ determined in a current recursion.

Based on the feedback information, the DCS controller 100 may decide whether the actual configuration of the scattering elements 131 meet the set requirements or not. In case the requirements are achieved, then the configuration of the DCS may end and communication can be established. Otherwise, the DCS controller 100 may perform, jointly with the BS 120, the recursive process explained above in this disclosure.

For example, the DCS controller 100 may select a tile and split it into two or more sub-tiles. The scattering elements 131 in each of the one or more sub-tiles may be configured through signaling and a pilot transmission may be requested. The pilot may be transmitted by the transmitting node 110 (UE) and received by the receiver node 120 (BS). Then, two or more effective concatenated channels via respectively the two or more sub-tiles may be estimated by the receiver node 120 and feedback to the control entity 100 may be reiterated.

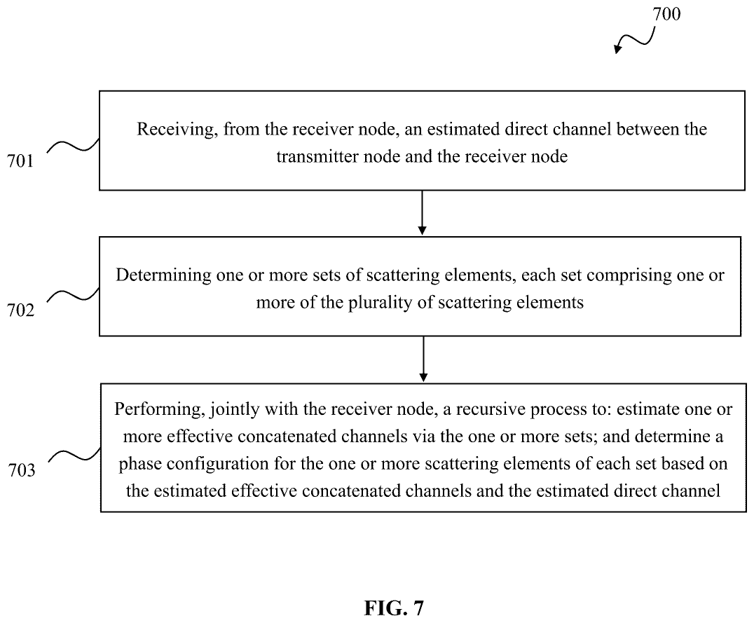

FIG. 7 shows a method 700 for a control entity 100 for a wireless communication system 1 according to this disclosure. The method 700 may be performed by the control entity 100 of FIG. 3 as disclosed above. The wireless communication system 1 comprises the receiver node 120, the transmitter node 110, the DCS 130 comprising a plurality of controllable scattering elements 131, and the control entity 100 as disclosed above.

The method 700 comprises operation 701 of receiving, from the receiver node 120 of the wireless communication system 1, an estimated direct channel 101 between the transmitter node 110 and the receiver node 120.

The method 700 further comprises operation 702 of determining one or more sets 132-1, 132-2 of scattering elements 131. Each set 132-1, 132-2 comprises one or more of the plurality of scattering elements 131.

Further, the method 700 comprises operation 703 of performing, jointly with the receiver node 120, a recursive process to estimate one or more effective concatenated channels 102-1, 102-2 between the transmitter node 110 and the receiver node 120 via respectively the one or more sets 132-1, 132-2 of scattering elements 131, and to determine a phase configuration 133-1, 133-2 for the one or more scattering elements 131 of each of the one or more sets 132-1, 132-2 based on the estimated effective concatenated channels 102-1, 102-2 and based on the estimated direct channel 101.

The method 700 may further comprise actions according to the described aforementioned exemplary embodiment of the control entity 100. Hence, the method 700 achieves the same advantages as the control entity 100 as disclosed above.

The present disclosure further provides a computer program product comprising a program code for carrying out, when implemented on a processor, the method 700 shown in FIG. 7. The computer program may be included in a computer readable medium of the computer program product. The computer readable medium may comprise essentially any memory, such as a ROM (Read-Only Memory), a PROM (Programmable Read-Only Memory), a 15 EPROM (Erasable PROM), a Flash memory, an EEPROM (Electrically Erasable PROM), or a hard disk drive.

The computer program product may further comprise actions according to the described aforementioned method 700. Hence, the computer program product achieves the same advantages as the method 700 and as the control entity 100.

The present disclosure has been described in conjunction with various embodiments as examples as well as embodiments. However, other variations can be understood and effected by those persons skilled in the art and practicing the claimed matter, from the studies of the drawings, this disclosure and the independent claims. In the claims as well as in the description the word “comprising” does not exclude other elements or operations and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous embodiment.

1. A control entity for a wireless communication system comprising:
a receiver node;
a transmitter node; and
a digitally controllable scatterer, comprising a plurality of controllable scattering elements, wherein the control entity is configured to:
receive, from the receiver node of the wireless communication system, an estimated-direct channel between the transmitter node and the receiver node;
determine one or more sets of scattering elements, wherein each set comprises one or more of the plurality of scattering elements;
perform, jointly with the receiver node, a recursive process to:
estimate one or more effective concatenated channels between the transmitter node and the receiver node via respectively the one or more sets of scattering elements; and
determine a phase configuration for the one or more scattering elements of each of the one or more sets based on the estimated effective concatenated channels and the estimated direct channel.

2. The control entity according to claim 1, further configured to:
determine a collection of available sets of scattering elements comprising the one or more sets of scattering elements;
receive, from the receiver node, an estimated initial effective concatenated channel between the transmitter node and the receiver node via one or more of the sets of scattering elements; and
determine a configuration for each of the plurality of scattering elements based on the estimated initial one or more effective concatenated channel and the estimated direct channel.

3. The control entity according to claim 2, wherein, to perform the recursive process, the control entity is configured to perform one or more recursions until a stop criterion is met, wherein, for each recursion, the control entity is configured to:
select at least one set of scattering elements from the collection of available sets based on a predefined selection criterion;
split the selected at least one set of scattering elements into two or more sub-sets, wherein each sub-set comprises one or more of the scattering elements of the respective at least one selected set;
determine a phase configuration for the one or more scattering elements of each sub-set;
estimate, by the receiver node, two or more new effective concatenated channels via respectively the two or more sub-sets of scattering elements;
determine an updated phase configuration for the scattering elements of each sub-set based on the respective two or more estimated new effective concatenated channels;
determine, by the receiver node, one or more quality metrics for the two or more sub-sets based on the respective two or more estimated new effective concatenated channels;
update the collection of available sets based on the determined two or more sub-sets; and
determine whether the predetermined criterion is met based on the one or more quality metrics determined by the receiver node.

4. The control entity according to claim 3, wherein to select the at least one set of scattering elements from the collection of available sets based on the predefined selection criterion, the control entity is further configured to:
select a set having a largest number of scattering elements; or
select the at least one set based on the one or more quality metrics determined in a previous recursion.

5. The control entity according to claim 3, wherein to split the selected at least one set of scattering elements into two or more sub-sets, the control entity is configured to:
use a predetermined splitting scheme with no prior information of at least one of the transmitter node or the receiver node of the wireless communication system;
use a splitting scheme comprising prior information of at least one of the transmitter node or the receiver node of the wireless communication system; or
use a random splitting scheme.

6. The control entity according to claim 3, wherein the one or more scattering elements of each of the two or more sub-sets are adjacent or nonadjacent.

7. The control entity according to claim 3, wherein to determine the phase configuration for the one more scattering elements of each sub-set, the control entity is configured to:
add a phase shift to a phase of the one or more scattering elements of the sub-set.

8. The control entity according to claim 3, wherein to update the collection of available sets based on the determined two or more sub-sets, the control entity is configured to:
replace, in the collection of available sets, the selected at least one set with the respective determined two or more sub-sets.

9. The control entity according to claim 3, wherein to determine whether the predetermined criterion is met based on the estimated quality metrics, the control entity is configured to:
receive, from the receiver node, the one or more determined quality metrics for the two or more sub-sets;
compare at least one of the determined quality metrics for the two or more sub-sets with a respective predetermined threshold value; and
determine if the predetermined criterion is met based on a result of the comparison.

10. The control entity according to claim 3, wherein the quality metric comprises at least one of an Instantaneous Tile-based Reference Signal Received Power (T-RSRP) or a Received Signal Strength (RSS).

11. A method for a control entity of a wireless communication system, the method comprising:
receiving, from a receiver node of the wireless communication system, an estimated direct channel between a transmitter node and the receiver node;
determining one or more sets of scattering elements, wherein each set comprises one or more of a plurality of scattering elements;
performing, jointly with the receiver node, a recursive process comprising:
estimating one or more effective concatenated channels between the transmitter node and the receiver node via respectively the one or more sets of scattering elements; and
determining a phase configuration for the one or more scattering elements of each of the one or more sets based on the estimated effective concatenated channels and the estimated direct channel.

12. The method according to claim 11, further comprising:
determining a collection of available sets of scattering elements comprising the one or more sets of scattering elements;
receiving, from the receiver node, an estimated initial effective concatenated channel between the transmitter node and the receiver node via one or more of the sets of scattering elements; and
determining a configuration for each of the plurality of scattering elements based on the estimated initial one or more effective concatenated channel and the estimated direct channel.

13. The method according to claim 12, wherein the recursive process comprises performing one or more recursions until a stop criterion is met, wherein each recursion comprises:
selecting, by the control entity, at least one set of scattering elements from the collection of available sets based on a predefined selection criterion;
splitting, by the control entity, the selected at least one set of scattering elements into two or more sub-sets, wherein each sub-set comprises one or more of the scattering elements of the respective at least one selected set;
determining, by the control entity, a phase configuration for the one or more scattering elements of each sub-set;
estimating, by the receiver node, two or more new effective concatenated channels via respectively the two or more sub-sets of scattering elements;
determining, by the control entity, an updated phase configuration for the scattering elements of each sub-set based on the respective two or more estimated new effective concatenated channels;
determining, by the receiver node, one or more quality metrics for the two or more sub-sets based on the respective two or more estimated new effective concatenated channels;
updating, by the control entity, the collection of available sets based on the determined two or more sub-sets; and
determining, by the control entity, whether the predetermined criterion is met based on the one or more quality metrics determined by the receiver node.

14. The method according to claim 13, wherein the selecting the at least one set of scattering elements from the collection of available sets based on the predefined selection criterion comprises:
selecting a set having a largest number of scattering elements; or
selecting the at least one set based on the one or more quality metrics determined in a previous recursion.

15. The method according to claim 13, wherein the selecting the at least one set of scattering elements from the collection of available sets based on a predefined selection criterion comprises:
selecting a set having a largest number of scattering elements; or
selecting the at least one set based on the one or more quality metrics determined in a previous recursion.

16. The method according to claim 13, wherein the one or more scattering elements of each of the two or more sub-sets are adjacent or nonadjacent.

17. The method according to claim 13, wherein the determining the phase configuration for the one more scattering elements of each sub-set comprises:
adding a phase shift to a phase of the one or more scattering elements of the sub-set.

18. The method according to claim 13, wherein the updating the collection of available sets based on the determined two or more sub-sets comprises:
replacing, in the collection of available sets, the selected at least one set with the respective determined two or more sub-sets.

19. The method according to claim 13, wherein the determining whether the predetermined criterion is met based on the estimated quality metrics comprises:
receiving, from the receiver node, the one or more determined quality metrics for the two or more sub-sets;
comparing at least one of the determined quality metrics for the two or more sub-sets with a respective predetermined threshold value; and
determining if the predetermined criterion is met based on a result of the comparison.

20. A non-transitory computer-readable storage medium configured to store instructions, wherein the instructions are configured to be executed by a processor to cause a control entity to:
receive, from a receiver node of a wireless communication system, an estimated direct channel between a transmitter node and the receiver node;
determine one or more sets of scattering elements, wherein each set comprises one or more of a plurality of scattering elements;
perform, jointly with the receiver node, a recursive process to:
estimate one or more effective concatenated channels between the transmitter node and the receiver node via respectively the one or more sets of scattering elements; and
determine a phase configuration for the one or more scattering elements of each of the one or more sets based on the estimated effective concatenated channels and based on the estimated direct channel.
